(19) United States
(12) Patent Application Publication
(10) Pub. No.: US 2003/0213906 A1
(43) Pub. Date: Nov. 20, 2003

(54) Method and apparatus for minimizing evaporation of a volatile substance

(75) Inventors: John Lennon, Gaithersburg, MD (US); Jack Goodman, Lusby, MD (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Large Scale Proteomics Corporation

(21) Appl. No.: 10/147,912

(22) Filed: May 20, 2002

(51) Int. Cl. H01J 49/04

(52) U.S. Cl. 250/288; 73/864.83

(57) ABSTRACT

A storage vessel is provided to reduce evaporation of volatile substances such as matrix solution used for preparing samples originating from electrophoresis gel slabs for mass spectrometry. The storage vessel is configured with a reservoir having a recess to accommodate the volatile substance. The reservoir includes a channel for receiving a heat exchange fluid to cool the liquid. The reservoir member has an inlet and an outlet for connection to a circulating chiller bath. The storage vessel is configured for transport using the conveyor of a biological sample preparation apparatus, such as an autopipetting device.

### FIELD OF THE INVENTION

The invention relates to a method and apparatus for minimizing evaporation of a volatile substance using a storage vessel that maintains the volatile substance at a sufficiently low temperature to reduce evaporation. The invention also relates to a method of improving preparation of sample supports, such as sample plates for mass spectrometry analysis, using a temperature controlled storage plate for conveyance with a sample plate or multiwell plate by an automated pipetting device or other biological sample preparation apparatus.

### BACKGROUND OF THE INVENTION

Mass spectrometry devices measure the molecular mass of a molecule by measuring the molecule's flight path through a set of magnetic and/or electric fields. Such devices are well known and are widely used in the field of chemical research. In proteomics research, for example, mass spectrometry is used to identify proteins.

Proteins are typically separated from one another by electrophoresis, such as the techniques described in U.S. Pat. No. 5,993,627 to Anderson et al. (hereinafter referred to as the Anderson et al. patent), which is incorporated herein by reference in its entirety. For instance, as set forth in the Anderson patent, a tissue sample is first subjected to a first dimension electrophoresis process where groups of proteins are separated linearly within a tubular gel-filled column. The first dimension separation of proteins is then inserted along an edge of a flat planar gel slab and subjected to a second dimension of electrophoresis, thereby generating a two dimensional pattern of spots formed by clusters of proteins that have moved to respective iso-electric focusing points. Thereafter, selected proteins are excised from the second dimension gel slab for further study. The selected excised spots are prepared for analysis using, for instance, mass spectrometry.

Various systems and methods have been proposed to overcome disadvantages associated with the volatility of the matrix solution in mass spectrometry. For example, U.S. Pat. No. 6,265,716 to Hunter et al. employs a cooling device (i.e., a liquid nitrogen cooled sample stage) inside the mass spectrometer to cool a sample plate. This apparatus and method is undesirable because it requires expensive and undesirable changes to existing mass spectrometry equipment. Alternatively, the sample plate (e.g., the MALDI plate) can be cooled. Mass spectrometry equipment, however, typically has a relatively small opening for receiving a sample plate into its vacuum chamber and therefore cannot accommodate a sample plate together with a cooling mechanism. Further, neither of these proposed devices addresses the volatility of a matrix solution that crystallizes prior to mass spectrometry.

One proposed method for cooling a matrix solution to reduce its evaporation while being applied to a sample plate is to create a chamber around the pipetting assembly, such as covering the assembly with a plastic cover and then regulating the temperature of the area enclosed by cover, or cooling the pipetting equipment (e.g., the conveyor) itself. Neither of these methods, however, is desirable. Cooling equipment that employs robotics such as the automated device is undesirable since expansion and contraction of the equipment due to temperature changes can make robotic maneuvers significantly less precise. Thus, deposits of sample on targets by the robotic devices would be much less precise and would potentially yield less useful data following mass spectrometry.

Accordingly, a need exists for an apparatus and method to reduce evaporation rates of volatile substances that arc often used in biological sample preparation and to produce more uniform sample spots for analysis.

### SUMMARY OF THE INVENTION

In accordance with the present invention, a storage plate containing a volatile substance is provided to reduce the evaporation rate of the volatile substance. In one embodiment, the invention is directed to a storage vessel for a solution containing a matrix compound used with samples originating from electrophoresis gel slabs.

In accordance with one aspect of the present invention, the storage device is a cold plate having a recess defining an internal cavity to accommodate the volatile substance. The cold plate includes a base forming a reservoir member having an internal channel for a coolant to cool the volatile substance to a sufficiently low temperature to reduce the rate of evaporation. The reservoir member has an inlet and an outlet for connection to a circulating chiller bath.

In accordance with another aspect of the present invention, the cold plate is configured for transport with a support plate or sample vessel using the conveyor of a biological sample preparation apparatus such as an autopipetting device.

In accordance with another aspect of the present invention, the cold plate includes a cooling device to cool the plate and reduce evaporation of a volatile substance that occurs when preparing samples and prior to analysis such as mass spectrometry.

In accordance with an embodiment of the present invention, a base member is configured to removably support a plate containing a volatile substance. The plate has a well or cavity for containing the volatile substance therein. The base member comprises a channel for directing the flow of a coolant therethrough to cool the plate to a temperature to reduce the rate of evaporation of the volatile substance. In a preferred embodiment a lid is coupled to the open top end of the plate to close the cavity and to reduce evaporation of the volatile substance. The lid includes a plurality of openings spaced apart a distance corresponding to the spacing of the pipette of the pipetting device to allow the pipettes to pass through the lid to withdraw a volume of the substance in the plate.

In accordance with another embodiment of the present invention, the cold plate includes a reservoir member configured to contain the volatile substance. The reservoir member includes a base member having a channel for directing flow of a coolant therethrough. A biological sample processing apparatus is operable to convey the volatile substance and the cold plate together using a transport device.

The aspects of the invention arc basically attained by providing a storage vessel for inhibiting evaporation of a liquid. The vessel comprises a reservoir having an open top end and an internal cavity for containing a liquid. A lid is coupled to the reservoir and closes the open top end. The lid has a plurality of spaced apart apertures extending between a top face and a bottom face. Each of the apertures have a dimension to allow a pipette to pass through the apertures in the lid into the internal cavity. A cooling member is operatively connected to the reservoir for cooling the internal cavity and the liquid.

The aspects of the invention are further attained by providing a pipetting apparatus for pipetting a liquid sample. The apparatus comprises at least one pipette, a sample receiving support, and a storage vessel having a closed reservoir with an internal cavity for containing a liquid. The storage vessel has at least one aperture extending into the cavity and has a dimension to allow the pipette to pass through the aperture. An operating assembly is provided to position the pipette in the aperture and to pipette a liquid sample from the storage vessel and to deposit the liquid sample onto the sample receiving support.

In accordance with an embodiment of the present invention, a method of reducing evaporation and loading a volatile liquid onto a support is provided. The method comprises the steps of providing a storage vessel which contains the volatile liquid and cools the volatile liquid to reduce evaporation. The storage vessel has a closed internal cavity and at least one aperture into the internal cavity. A volume of the volatile liquid is aspirated into a pipette and deposited onto a sample on the support plate.

The aspects of the invention a further attained by providing a method of forming a sample onto a mass spectrometry support plate. The method comprises the steps of depositing a sample onto a mass spectrometry support plate, providing a volatile solvent in a storage vessel and maintaining the solvent at a temperature below room temperature to inhibit evaporation. A volume of the solution is aspirated from the storage vessel in a pipette and at least a portion of the volume is deposited onto the sample on the support plate. The sample is dispersed in the solution and the solution is evaporated and a matrix forming material is crystallized on the support plate.

The objects, advantages and salient features of the invention will become apparent to one skilled in the art in view of the following detailed description of the invention in conjunction with the annexed drawings which form a part of this original disclosure.

### BRIEF DESCRIPTION OF THE DRAWINGS

The various aspects, advantages and novel features of the present invention will be more readily comprehended from the following detailed description when read in conjunction with the appended drawings, in which:

FIG. 1 is a front view of the autopipetting device for depositing samples on the sample plate;

FIG. 2 is a top view of an exemplary support plate for a mass spectrometer;

FIG. 3 is a side view of the support plate of FIG. 2;

FIG. 4 is a top view of the storage vessel in accordance with an embodiment of the present invention;

FIG. 5 is a front view of the storage vessel of the embodiment of FIG. 4;

FIG. 6 is an exploded front view of the storage vessel of FIG. 4;

FIG. 7 is an exploded cross sectional front view of the storage vessel taken along line 7-7 of FIG. 4;

FIG. 8 is a top view of the storage plate;

FIG. 9 is a front view of the storage plate;

FIG. 10 is a top view of the base member showing the channel for the cooling fluid;

FIG. 11 is a side view of the base member of FIG. 10;

FIGS. 12 and 13 are front views of the autopipetting device showing storage vessel in the lowered and raised position, respectively;

FIG. 14 is a cross sectional side view of the storage plate positioned below and aligned with the pipettes;

FIG. 15 is a cross sectional view showing the pipettes extending through the opening in the lid;

FIG. 16 is a front view of the pipetting apparatus showing the sample plate in the raised position to receive the test samples.

### DETAILED DESCRIPTION OF THE INVENTION

In accordance with the present invention, a storage vessel is provided for use with an apparatus to deposit a sample and a volatile solvent or solution of a mass spectrometry matrix material onto a sample plate or other support. The apparatus in the illustrated embodiment is an automated pipetting device (APD). It is to be understood, however, that the present invention can be used in conjunction with other devices that involve dispensing or application of volatile substances and particularly where very small volumes of volatile liquids are being dispensed. The liquid preferably contains a solute such as a matrix material.

In the various embodiments disclosed herein, the method and apparatus are primarily for preparing biological samples on a mass spectrometry plate for mass spectrometry analysis. Samples for MALDI-TOF analysis generally contain a matrix material that is deposited on the sample plate and forms a matrix with the sample being analyzed. The matrix material can be dissolved in a volatile organic solvent and deposited into a sample where the solvent evaporates and crystallizes. The matrix solution and the volatile solvent or other organic components is generally subject to high rates of evaporation at room temperature, particularly when a sample plate 10 is being prepared. Alternatively, a solution of the matrix material and the sample being analyzed can be prepared and deposited onto the support plate.

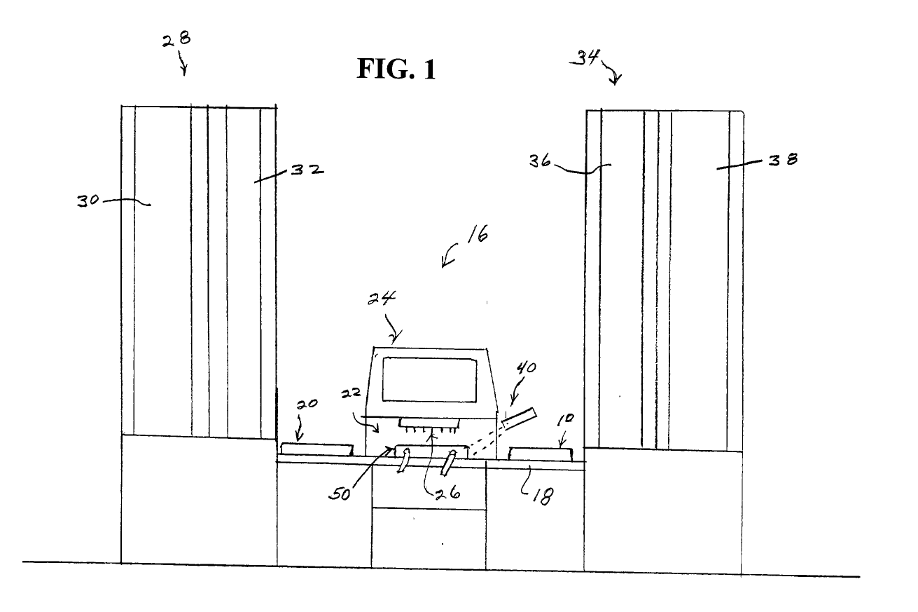

Sample plates 10 are often prepared using an autopipetting device (APD) 16 as shown in FIG. 1. A suitable autopipetting device is the CyBi-Well device, which is commercially available from CyBio AG, Jena, Germany. In the illustrated embodiment, the APD 16 has a conveyer 18 to move multiwell plates (e.g., microtiter plates) 20 and sample plates 10 in a transverse direction with respect to different stations provided on the APD 16. The APD includes, for example, a pipetting station indicated generally at 22 and a first carousel 28 with sections 30 and 32 for housing sampled and unsampled multiwell plates, respectively, and delivering the multiwell plates to the conveyor 18. APD 16 can also include a pipette tip rinsing station, a bar code reader or a transponder reader 40 for reading bar codes provided on sample plates 10 and the multiwell plates containing the samples to be analyzed, and a second carousel 34 with sections 36 and 38 for housing, respectively, clean sample plates 10 and spotted sample plates and delivering the sample plates to the conveyor 18. Preferably, the sample plates and the multiwell plates containing the sample to be analyzed have a bar code that can be detected and read by bar code reader 40 so that each sample plate can be associated with a known sample from the multiwell plate. The APD 16 also has a lifter assembly to raise and lower sample plates 10 and the multiwell plates in the vertical direction in the pipetting station 22.

A programmable control device indicated generally at 24 is provided for automatically controlling the conveyer 18, the lifter assembly and the operation of the pipettes. The programmable control device 24 comprises a user interface such as a display and keypad to allow a user to selectively program and control the timing for raising and lowering of the plates with respect to the pipettes 22 and the volume of materials being pipetted. Preferably, the plates are raised and lowered with respect to the pipettes by retractable members that engage the bottom of the plate. Thus, through the sequential movement of multiwell plates and the sample plates by the conveyor 18, the APD 16 can be operated to obtain a sample, matrix material and various reagents via the pipettes from different multiwell plates and deposit the materials onto target areas of the sample plate 10 in a predetermined sequence.

In one embodiment, a solution of a matrix material is deposited onto a sample spot that was previously deposited on the sample plate. The matrix solution is deposited in an amount to disperse the sample so that when dried, the biological sample is dispersed in the crystallized matrix material in a suitable ratio of the matrix material to the biological sample suitable for mass spectrometry. The matrix solution generally includes an organic solvent that is volatile at room temperature and at ambient or reduced pressures. The use of a volatile matrix solution therefore presents challenges when preparing the sample spots on the sample plate since the volatility of the matrix solvent makes it difficult to obtain uniform crystallization of the matrix material and sample on the MALDI plate. The evaporation of the solvent from the matrix solution during loading results in variations in the total amount of matrix material deposited onto the sample plates. During the loading process where numerous sample plates are loaded sequentially by the automated pipetting device, the solvent can evaporate, thereby continuously changing the concentration of the solution throughout the process. As the concentration of the matrix solution increases, the ratio of the amount of the matrix material to the amount of the sample material changes which produces inconsistent results in the mass spectrometry analysis. The manner in which samples crystallize on a MALDI plate has significant effect on the ability of the mass spectrometer to achieve meaningful and consistent data. It is therefore desirable to control and maintain a constant concentration of the matrix compound in the solution for a group of samples, as well as the overall stability of the matrix solution to ensure optimal crystallization of the matrix material and sample on the target spots of the MALDI plate.

In one embodiment a matrix-assisted laser desorption ionization (MALDI) time-of-flight (TOF) mass spectrometry apparatus is used to analyze a biological sample, such as an excised spot that has been extracted from the gel slab. The biological sample is embedded in a crystallized matrix material which is subsequently vaporized by an intense laser emission. In the field of proteomics, mass spectrometry, and in particular, MALDI-TOF techniques are used to determine the molecular weight of peptides produced by digestion of isolated proteins.

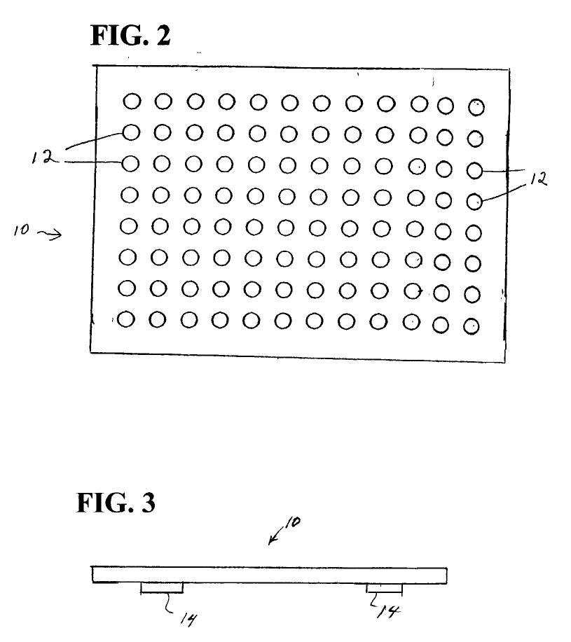

In preferred embodiments, the test samples are biological samples and proteins. The selected extracts of excised spots obtained from an electrophoresis gel are typically deposited on a support, such as a mass spectrometer sample plate 10, to form a sample spot as shown in FIGS. 2 and 3. The excised gel spots from the gel slab are typically treated with a protease or other specific cleaving agent which cleaves the protein that is present into peptides. These peptides are then extracted, mixed with a solution of the matrix material and then placed and optionally crystallized on the sample plate. Alternatively, the peptides or other sample is deposited on the sample plate and a solution of a matrix material is deposited on top of the sample. The sample disperses in the solution and the solvent evaporates to crystallize the matrix material with the sample contained therein. Typically, the sample plate 10 is inserted into a slot in the positioning mechanism of a MALDI-TOF mass spectrometry apparatus and is thereafter held in a specific orientation within the positioning mechanism for sample analysis. The sample plate 10 typically holds a plurality of target areas for receiving discrete samples 12 on one surface thereof, with the samples being spaced apart from one another. In the illustrated embodiment, the sample plate includes legs 14 that function as guide members that cooperate with a recess within the positioning mechanism of the MALDI-TOF apparatus.

MALDI-TOF mass spectrometry targets laser pulses focused on the samples of the sample plate. Typically, the analyte molecules of the samples are embedded in either a solid or liquid matrix material. The matrix material is usually applied to the sample plate as a solution or dispersion in one or more solvents, such as acetonitrile and ethanol. The matrix material can be selected from, for example, cinnamic acid and derivatives thereof to form samples 12. Other matrix materials suitable for use in mass spectrometry analysis can also be used as known by those skilled in the art. The samples 12 are analyte molecules that have been crystallized with a relatively large molar excess of a matrix material. The matrix material is preferably a laser energy absorbing material. The ionization of intact molecules, such as the analyte molecules, benefits from the use of matrix-assisted laser desorption ionization because the energy from the laser pulse is coupled indirectly to the analyte through the matrix molecules.

Referring to FIG. 1, pipetting assembly 16 includes conveyor 18 having a base for reciprocating in a track extending between a stacking device 28 and stacking device 34. In the illustrated embodiment, the conveyor 18 supports microtiter plate 20, storage vessel 50 and a sample plate 10 for moving along the length of the track between various operating positions as discussed hereinafter in greater detail. Pipetting assembly 16 includes a plurality of micropipettes 26 extending downwardly toward conveyor 18. Micropipettes 26 are standard pipettes for pipetting small volumes of liquids, typically a few microliters, as known in the art. The micropipettes 26 are connected to a pump that is operated by the control assembly 24 to draw and discharge a liquid in a coordinated fashion with the movement of conveyor 18.

The control assembly 24 of pipetting assembly 16 selectively moves conveyor 18 to position the microtiter plate 20 below the micropipettes 26. The lifting device of the pipetting assembly raises the microtiter plate 20 to insert the micropipettes 26 into the respective well to enable micropipettes to withdraw a sample. The lifting device lowers the microtiter plate 20 onto the conveyor 18. Conveyor 18 then moves to position sample plate 10 below the micropipettes 26. Sample plate 10 is raised to a position to enable the micropipettes 26 to deposit the sample onto the sample plate 10. Micropipettes 26 are stationary and arranged in an array of rows or columns to complement the position of the wells in the microtiter plate 20 and the arrangement of the sample spots 12 on the sample plate 10. In one preferred embodiment, assembly 16 includes a number of micropipettes 26 corresponding to the number and location of the wells of the microtiter plate so that each micropipette can be inserted into a respective well simultaneously. The pipettes are then able to deposit the liquid onto the support simultaneously to form the sample spots.

In one embodiment of the invention a matrix material is deposited on the sample spots 12 for analysis by mass spectrometry. In a preferred embodiment of the invention, the matrix forming material is deposited as a solution onto the sample spots 12 to disperse the sample being analyzed in the matrix solution. The matrix solution contains a volatile solvent or carrier that evaporates quickly to form a dry or crystallized matrix material containing the test sample dispersed therein. The matrix compound can be selected from, for example, alpha-cyano-4-hydroxycinnamic acid, sinapic acid, 2-(4-hydroxyphenylazo)benzoic acid, succinic acid, 2,6-dihydroxyacetophenone, ferulic acid, caffeic acid, glycerol, 4-nitroaniline, 2,4,6-trihydroxyacetophenone, 3-hydroxypicolinic acid, anthranilic acid, nicotinic acid, salicylamide, trans-3-indoleacrylic acid dithranol, 2,5-dihydroxybenzoic acid, isovanillin, 3-aminoquinoline, dithranol, t-2(3-(4-t-butyl-phenyl)-2-methyl-2-propenylidene)malononitrile, or 1-isoquinolinol. The matrix solution contains the matrix compound in a concentration so that an appropriate amount of the matrix compound is combined with the sample compound for mass spectrometry analysis. Similarly, the pipetting apparatus deposits an amount of the solution onto the sample to provide a proper ratio of the matrix material to the sample for mass spectrometry analysis.

Referring to FIG. 1, the matrix material dispersed or solubilized in a volatile liquid is contained in a storage vessel 50 that is mounted on conveyor 18. As discussed hereinafter in greater detail, conveyor 18 moves storage vessel 18 to a position below micropipettes 26. Storage vessel 50 is then raised upward to a position where micropipettes 26 can withdraw an amount of the matrix solution. Storage vessel 50 is lowered back onto convey 18 and sample plate 10 is moved into position below micropipettes 26. Sample plate 10 is then raised into a position and micropipettes 26 deposit the solution of the matrix material onto each of the test samples.

In the embodiments shown, the test samples are biological samples although other materials can be pipetted using the assembly. The sample plates 10 are standard mass spectrometry plates as known in the art. The number and spacing of the samples on the sample plate can vary depending equipment being used. In alternative embodiments the test samples can be deposited on other support members or vessels.

In an alternative embodiment, the sample plate 10 can be prepared with sample spots of the material to be analyzed and a dry matrix material. The pipetting assembly then deposits an amount of an organic solvent onto the spots to dissolve the matrix material and disperse the sample material. The solvent then evaporates and the matrix material crystallizes.

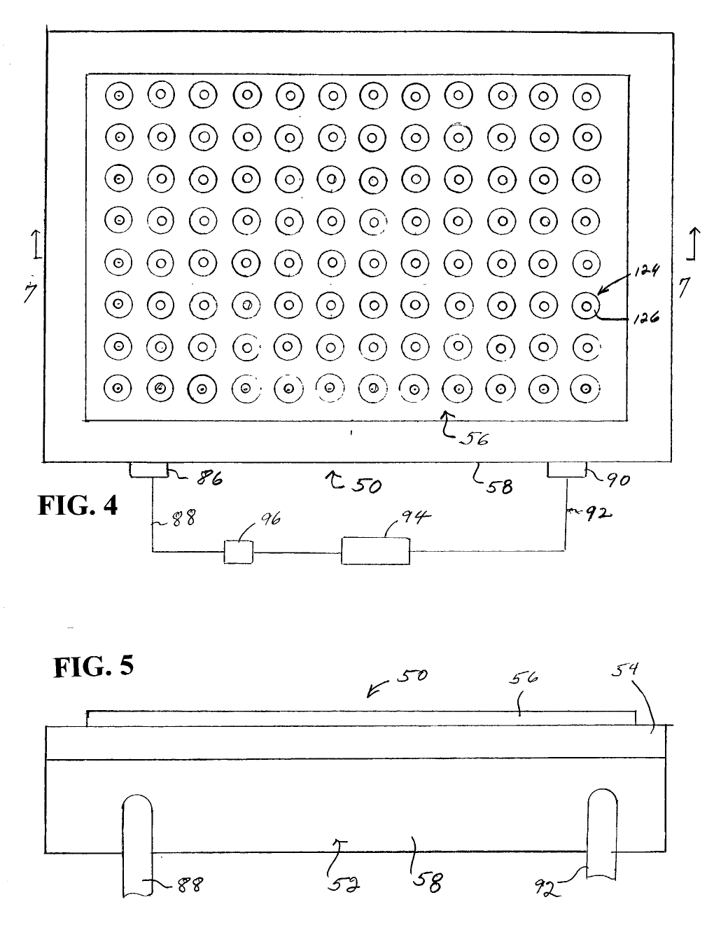

Referring to FIGS. 4 and 5, the storage vessel assembly defines storage device 50 for containing a volatile substance at a temperature to inhibit the rate of evaporation. Storage device 50 includes a base 52, a top plate 54 and a lid 56 as shown in FIGS. 4 and 5. As discussed hereinafter, base 52 and top plate 54 form a reservoir for containing a matrix solution.

As used herein, the term “volatile” and “volatile solvent” refers to a substance and particularly a liquid that has a high rate of evaporation at room temperature and at atmospheric pressure. The invention is particularly suitable for dispensing volatile liquids or solutions of a material where the evaporation rate of the solvent system is such that the concentration of the solvent can change during the normal time period that the pipetting apparatus is operated. In certain embodiments of the invention, the liquid has a vapor pressure of at least about 3.5 kPa at 25° C. and typically, at least about 7.0 kPa at 25° C. Typically, the volatile substance is an organic solvent suitable for use in dissolving and dispersing a matrix material for forming sample spots for mass spectrometry analysis. Examples of suitable organic liquids include acetonitrile and ethanol, which are commonly used to solubilize the matrix material. In one preferred embodiment, the volatile substance is a solution of a matrix-forming material in a solvent such as acetonitrile. The organic solvent typically has a rate of evaporation at room temperature and atmospheric pressure, greater than water and evaporates quickly at room temperature. In embodiments, the volatile organic liquids have a vapor pressure of about 7.0 kPa and above. In another embodiment, the volatile liquid has a vapor pressure of about 11 kPa and above at 25° C. In one embodiment, the solvent for the matrix forming material is acetonitrile which has a vapor pressure of 11.8 kPa at 25° C.

In one embodiment of the invention, the storage vessel 50 contains a solution of a matrix-forming material and a volatile solvent to having predetermined concentration of the matrix forming material suitable for use in mass spectrometry analysis as known in the art. Alternatively, the storage vessel 50 can contain a solvent without the matrix material. The concentration of the matrix-forming material is selected to form a suitable matrix with the biological sample for mass spectrometry analysis. The storage vessel 50 preferably maintains the solution of the matrix-forming material and the volatile liquid at a temperature to minimize evaporation of the volatile liquid during the loading of the sample spots onto the mass spectrometry sample plate 10. Preferably, the liquid is maintained below room temperature. Generally, the liquid is maintained between about 5° C. and 20° C., and typically about 10° C. to 15° C. By preventing or minimizing evaporation of the solvent, the concentration of the matrix-forming material remains constant or near constant throughout the loading process. By maintaining the concentration at a constant or near constant level, a large number of mass spectrometry plates can be loaded in sequence by the automated pipetting device where each sample spot contains substantially the same amount of the matrix-forming material. Where the evaporation of the volatile solvent is not controlled, the solvent continuously evaporates during the loading process and between the loading of a large member of sample plates so that the concentration of the matrix-forming material is constantly changing. The automated pipetting device 16 is programmed to dispense a predetermined volume of material onto each of the mass spectrometry sample plates 10. When the concentration of the solution constantly changes, the amount of the matrix-forming material deposited on the plates constantly varies, which produces inconsistent analytical results between different plates. By controlling the rate of evaporation of the volatile solvent as in the present invention, the concentration of the matrix-forming material remains constant so that uniform amounts of the matrix-forming material can be deposited on each of the sample plates 10.

Storage vessel 50 is constructed for coupling with conveyor 18 and for containing a solution of a matrix material during the loading of test samples onto the mass spectrometry sample plate 10. Storage vessel 50 is constructed to minimize evaporation of the volatile solvent to maintain a substantially uniform concentration of the matrix material in the solution. In preferred embodiments of the invention, storage vessel 50 includes a cooling device to maintain the volatile solution at atmospheric pressure and at a temperature to minimize evaporation. In the illustrated embodiment, storage vessel 50 receives a cooling medium to cool the solvent or solution. Preferably, storage vessel 50 is made of a polymeric material that is non-reactive with the matrix solution. A suitable material is a structural nylon sold under the tradename DELRIN.

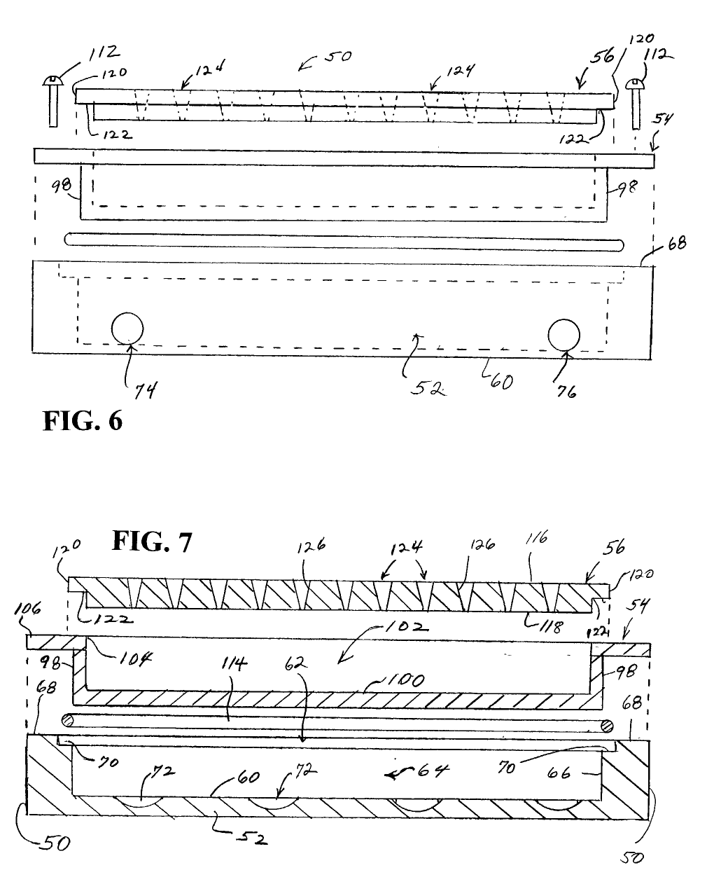

Base 52 of storage vessel 50 as shown in FIG. 6 has a substantially rectangular configuration with side walls 58 extending upwardly from a bottom wall 60. Base 52 has an open top end 62 defining a cavity 64. Side walls 58 in the embodiment illustrated have a substantially straight inner face 66 extending substantially perpendicular to bottom wall 60. Side walls 58 have a top face 68 and a ledge 70 at top face 68 and inner face 66 as shown in FIG. 7.

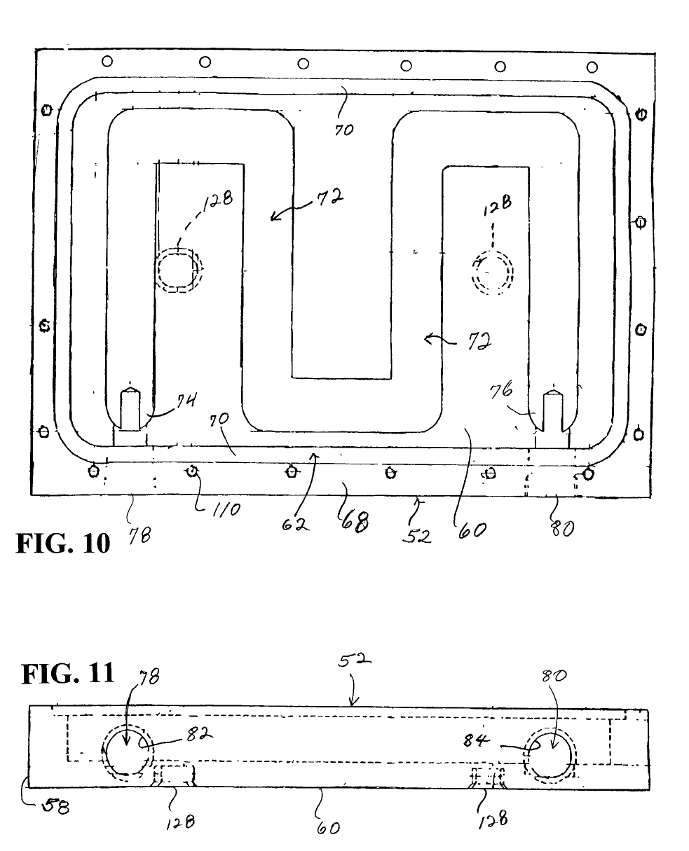

Referring to FIGS. 10 and 11, bottom wall 60 of base 52 includes a recessed channel 72 facing upward into cavity 64. In the embodiment illustrated, channel 72 has an open top end and extends in a generally serpentine path. Channel 72 has a receiving end 74 adjacent side wall 58 and a discharge end 76 adjacent the same side wall 58 as receiving end 74. In the embodiment illustrated in FIG. 7, channel 72 has a substantially arcuate shape cross-section and has a dimension to receive a heat exchange fluid, and particularly a cooling fluid as discussed hereinafter in greater detail.

Base 52 preferably includes an inlet and an outlet for supplying the cooling fluid to channel 72 to flow from receiving end 74 to discharge end 76. In the embodiment illustrated, side wall 58 includes an inlet port 78 aligned with receiving end 74 of channel 72. Side wall 58 also includes an outlet port 80 aligned with discharge end 76 of channel 72. Typically, inlet port 78 and outlet port 80include a threaded inner surface 82 and 84 respectively for receiving a suitable coupling member for connecting channel 72 to a fluid source. As shown in FIG. 4, a coupling member 86 is coupled to inlet port 78 and is connected to a fluid supply line 88. A coupling 90 is connected to outlet port 80 and is connected to a discharge line 92. In the embodiment illustrated, a cooling device 94 and a pump 96 are connected to fluid supply line 88 for supplying a cooled fluid to channel 72. Discharge line 92 is connected to cooling device 94 to define a closed circulating system for the cooling fluid.

Typically, the cooling fluid is water and cooling device 94 is a suitable chilling or refrigeration device known in the art. A suitable chilling device is available under the tradename Merlin M25 Series by Thermo NESLAB of Portsmouth, N.H. Cooling device 94 is capable of maintaining the cooling fluid at a temperature sufficiently low to minimize evaporation of the volatile solution contained in storage vessel 50. In general, the cooling device 94 cools the cooling fluid in a range of about 5° C. to 25° C., preferably a temperature of about 20° C. or less, and preferably, a temperature of about 15° C. or less. In alternative embodiments, cold tap water can be circulated through channel 72 to provide a cooling effect.

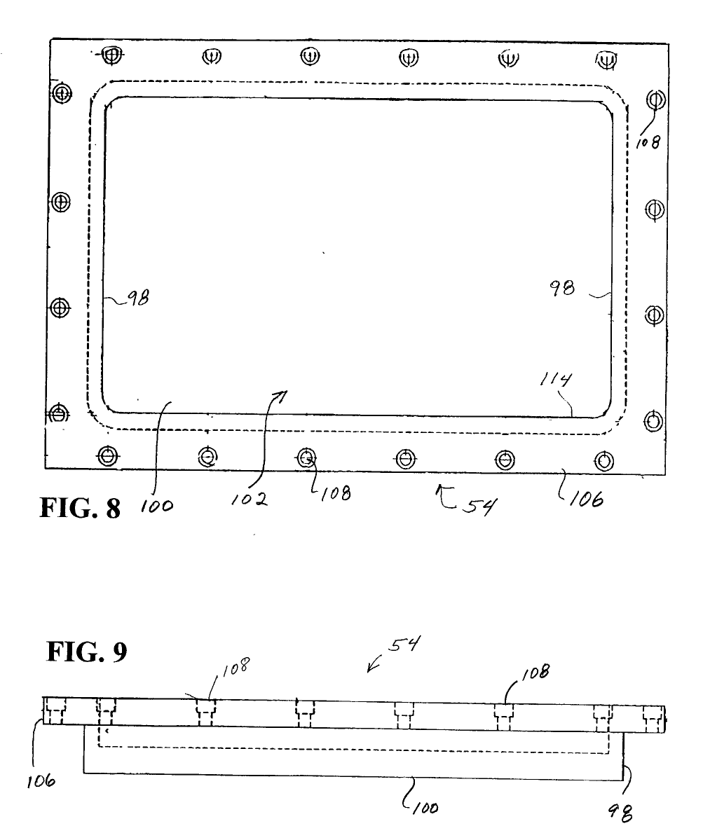

Referring to FIGS. 6-9, top plate 54 has a generally rectangular configuration complementing the dimension of base 52. Top plate 54 includes side walls 98 extending upwardly from a bottom wall 100 to define an internal cavity 102 having a dimension to contain a volume of the volatile solution. Typically, cavity 102 has a volume of about 10-30 ml. Side walls 98 have a top end 104 and a continuous outwardly extending radial flange 106. Top plate 54 has a dimension to fit within cavity 64 of base 52 as shown in FIG. 7. Top plate 54 is able to nest in cavity 64 so that bottom wall 100 of top plate 54 contacts or is closely spaced to bottom wall 60 of base 52 to substantially close the open top end of channel 72. Bottom wall 100 can include a channel to complement channel 72 of base 50. As shown in FIGS. 8 and 9, flange 106 of top plate 54 includes a plurality of spaced apart apertures 108 that align with apertures 110 in top face 68 of base 52 as shown in FIG. 10. In one embodiment of the invention, apertures 110 in base 52 have internal threads for mating with screws 112 for coupling top plate 54 with base 52. Preferably, a continuous gasket 114 is received in ledge 70 to form a fluid tight seal between flange 106 and top face 68 of base 52.

Lid 56 is dimensioned to fit onto top plate 54 and to enclose cavity 102 of top plate 54. Lid 56 has a substantially planar configuration with a top face 116 and a bottom face 118. A flange 120 extends radially outward from lid 56 to define a ledge 122. Flange 120 and ledge 122 are dimensioned to nest in the open top end of cavity 102 so that flange 120 rests on flange 106 of top plate 54 to close cavity 102. Lid 56 can be coupled to top plate 54 by a friction fit or other fastening member. Typically, lid 56 is removable to allow cleaning of the assembly. In one embodiment, lid 56 is secured to top plate 54 where cleaning of the assembly is not required.

Lid 56 includes a plurality of apertures 124 extending between top face 116 and bottom face 118. Apertures 124 have a substantially conical shaped inner surface converging toward bottom face 118 as shown in FIG. 7. Typically, apertures 124 are of a uniform shape and size. In other embodiments, the apertures 124 can have a semi-circular cross-section. Preferably, apertures 124 have a dimension at top face 116 of lid 56 to receive a respective pipette 26 while allowing for some misalignment of the respective pipette with apertures 124. Apertures 124 have a dimension at bottom face 118 to allow micropipette 26 to extend through the aperture in lid 56 into cavity 102 of top plate 54. In the embodiment shown in FIG. 4, apertures 24 are oriented in an array of rows and columns corresponding to the orientation of micropipettes 26 of the pipetting apparatus 16. In other embodiments, the rows of apertures 24 are staggered and the apertures of an adjacent row are offset from each other. Preferably, lid 56 has a dimension to close open top end of cavity 102 of plate 54. Cavity 102 of top plate 54 preferably has a volume to contain a suitable amount of a solution containing a matrix material for use in pipetting assembly 16. Bottom wall 60 of base 52 in one embodiment in the invention includes two recesses 128 for mating with conveyor 18 and the lifting mechanism for lifting storage vessel 50 into position for cooperating with micropipettes 26.

Apertures 124 are dimensioned to receive the pipette while minimizing evaporation of the solvent or solution. Typically, the apertures encompass less then 10% of the surface area of the lid, and preferably about 1% to about 5% of the top surface area of the lid.

In one embodiment, storage vessel 50 is filled with the appropriate solvent or solution by a suitable pipette from a supply reservoir. The pipette can be inserted through one of the apertures in the lid and dispense an amount of the solvent or solution to replenish the storage vessel. In another embodiment, storage vessel 50 can include an inlet through a side wall to refill the storage vessel.

The automated pipetting apparatus can have any desired number and orientation of pipettes. In one embodiment, the pipetting apparatus includes 96 pipettes oriented and spaced so that such pipettes can be inserted into a well of a standard 96-well microtiter plate. In another embodiment, a single row of pipettes can be used to aspirate the liquid and deposit the liquids sequentially in rows onto the sample plate.

Typically, the lid fits onto the top plate of the storage vessel to close the internal cavity of the storage vessel. In one embodiment, a film or sheet can be provided on the bottom face of the lid to form a seal to prevent evaporation of the liquid until ready for use. The film is sufficiently thin so the pipette easily pierces the film when inserted through the apertures.

The automated pipetting device is programmed to aspirate a desired volume of the liquid materials and dispense a desired amount onto the sample plate. The pipetting device can dispense the entire amount of the aspirated liquid onto the sample plate. In one embodiment, the pipette device is programmed to dispense less than the full amount of the aspirated volume onto the sample plate. Dispensing a portion of the liquid reduces the risk of spattering the liquid when it is dispensed.

In the operation of the automated pipetting apparatus 16, a multiwell microtiter plate 20 is automatically delivered from stacking assembly 28 to conveyor 18 as shown in FIG. 1. Conveyor 18 travels along the track and positions microtiter plate 20 below micropipettes 26 and lifts microtiter plate 20 upwardly to insert micropipettes 26 into a respective well of microtiter plate 20. Pipetting control unit 24 actuates a pump and withdraws a predetermined volume of the samples contained in microtiter plate 20 into micropipettes 26. The volume of the samples pipetted onto sample plate 10 is suitable for mass spectrometry analysis as known in the art. Typically, the volume of the sample is about 1-3 microliters. Microtiter plate 20 is then lowered onto conveyor and a sample plate 10 is conveyed into position below micropipettes 26. Sample plate 10 is raised into proximity with micropipettes 26 and the test samples are then deposited directly onto sample plate 10. Sample plate 10 is then lowered back onto conveyor 18. In one embodiment, automated pipetting device 16 includes a source of a wash liquid that is dispensed through micropipettes 26 into a collection vessel to wash residue from micropipettes 26 between cycles. Alternatively, pipetting device 16 includes a rinse station where a vessel or multiwell plate containing a rinse solution is raised into contact with micropipettes 26 where a volume of the rinse solution can be drawn into and dispensed form micropipettes 26.

Once the test samples are deposited on sample plate 10, a solution of a matrix forming material is deposited onto each of the test samples. Sample vessel 50 contains a solution of a suitable matrix material at a predetermined concentration suitable for dispersing the test sample in a matrix for mass spectrometry analysis. Automated pipetting apparatus 16 is programmed to withdraw a predetermined volume of the solution of the matrix material from sample plate 50 and deposit the solution of the matrix material on each of the test samples. Typically, the volume of the matrix solution deposited on the sample plate is about 1-3 microliters. The solution of the matrix material disperses the test sample so that when the volatile solvent evaporates the test sample is dispersed in a solid matrix material on sample plate 10.

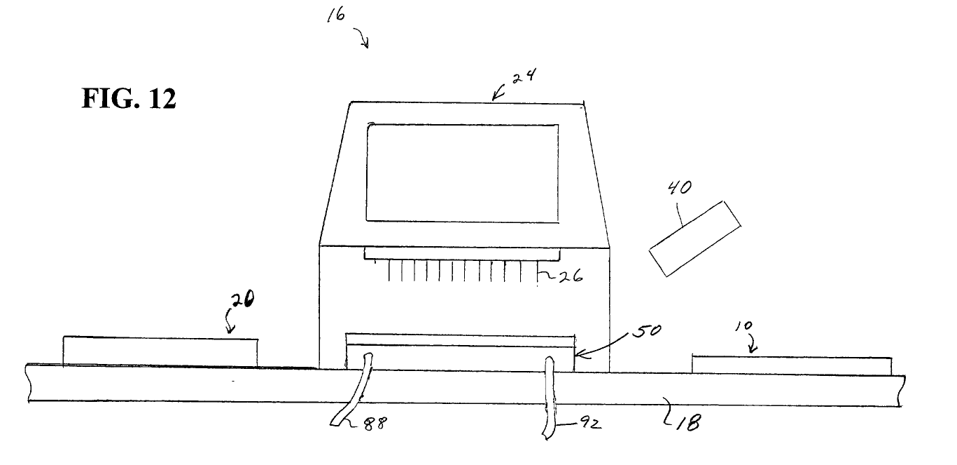

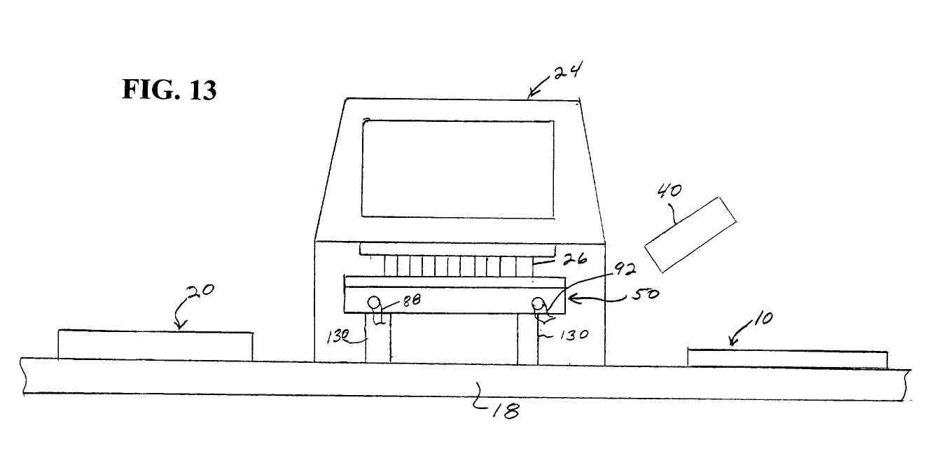

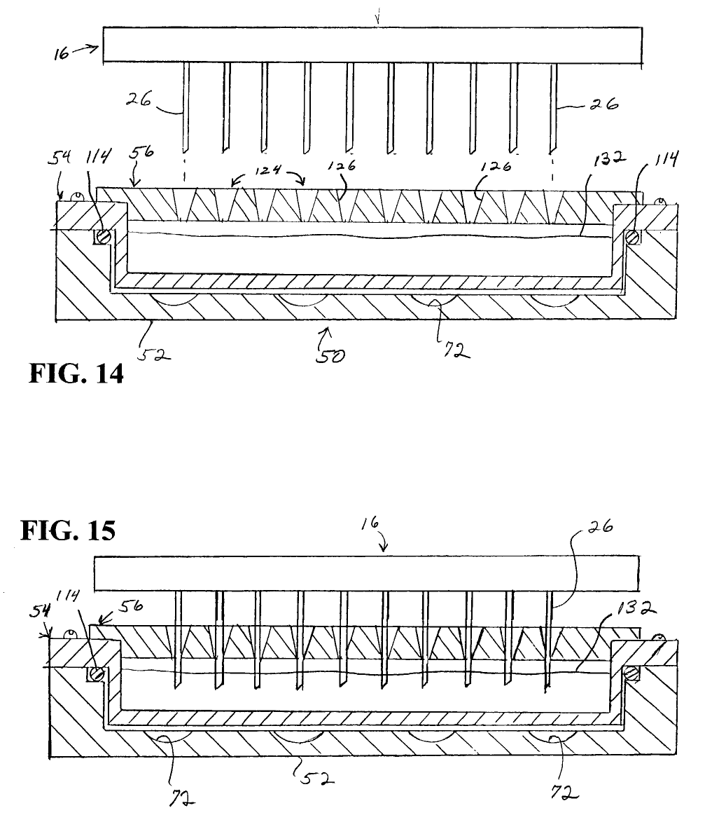

Referring to FIG. 12, after the test samples are deposited on the sample plate 10, conveyor 18 conveys storage vessel 50 to a position below micropipettes 26. The lifting assembly such as reciprocating plungers 130 lift storage vessel 50 upwardly so that micropipettes 26 extend through apertures 124 into a solution 132 of a matrix forming material. As shown in FIGS. 14 and 15, conical surfaces 126 of apertures 124 are aligned with micropipettes 26 to guide micropipettes 26 through apertures 124 into solution 132. When micropipettes 26 are positioned in solution 132 as shown in FIG. 15, control system 124 actuates a pump to withdraw a predetermined volume of the solution 132 into micropipettes 26.

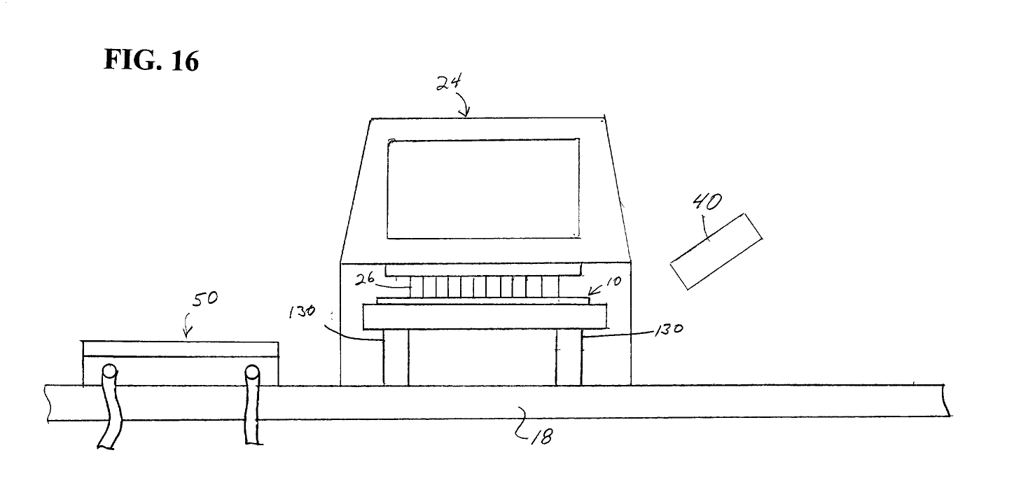

Storage vessel 50 is then lowered back onto conveyor 18 and sample plate 10 is conveyed to a position below micropipettes 26. Plungers 130 raise sample plate 10 upwardly into proximity with micropipettes 26 and the solution 132 of the matrix material is deposited indirectly onto the test sample spots on sample plate 10 as shown in FIG. 16. Sample plate 10 is then conveyed to stacking assembly 34 for storage until ready for delivering to the mass spectrometer for analysis of the test sample. The process is repeated for each sample plate to load the samples onto the plates for analysis.

The pipetting apparatus 16 in the illustrated embodiment is used for forming sample spots on a sample plate for mass spectrometry analysis. In other embodiments of the invention, the pipetting apparatus and storage vessel can be used to deliver small volumes of a liquid material to a suitable support member. The pipetting apparatus is particularly suitable for delivering volatile liquids and particularly volatile liquids containing a solute to minimize or reduce evaporation until the liquid is delivered to the target site.

In the above described embodiments, the test sample and solution of the matrix material are deposited on the sample plate in sequential steps. In an alternative embodiment, a mixture sample spots and a matrix material are formed on the sample plate. The sample material and the matrix material can be combined and applied to the sample plate as a mixture. The matrix material can be deposited onto the sample plate as a dry material or as a solution which is then dried. An amount of a suitable organic solvent is then deposited onto the sample spots using the pipetting assembly of the invention to dissolve the matrix material and disperse the sample material. The solvent is allowed to evaporate and to crystallize.

The pipetting apparatus in the illustrated embodiment provides stationary pipettes and moves the respective container into position and lifts the container into contact with the pipettes. It will be understood that other automated pipetting devices can be used that have movable arms carrying the pipettes that can move between various operating positions.

Pipetting apparatus 16 is an example of one type of device. In alternative embodiments, the pipetting apparatus can have one or more movable pipettes where the sample plates and multiwell plates are stationary. In the illustrated embodiments, the matrix solution is cooled until deposited on the sample plate, which is generally at room temperature. In alternative embodiments, the sample plate can also be cooled to control the rate of evaporation on the plate.

While various embodiments have been chosen to illustrate the invention, it will be understood that various changes and modifications can be made without departing from the scope of the invention as defined in the appended claims.

What is claimed is:

1. A storage vessel for inhibiting evaporation of a liquid, said vessel comprising:
a reservoir having an open top end and an internal cavity for containing a liquid;
a lid coupled to said reservoir and closing said open top end, said lid having a plurality of spaced apart apertures extending between a top face and a bottom face, each of said apertures having a dimension to allow a pipette to pass through said apertures in said lid into said internal cavity; and
a cooling member operatively connected to said reservoir for cooling said internal cavity.

2. The storage vessel of claim 1, wherein said cooling member comprises an internal channel in said reservoir for receiving a heat exchange fluid to cool said internal cavity.

3. The storage vessel of claim 2, further comprising a fluid inlet for supplying said heat exchange fluid to said internal channel and a fluid outlet for discharging said heat exchange fluid from said internal channel.

4. The storage vessel of claim 3, further comprising a heat exchange device for receiving and cooling said heat exchange fluid.

5. The storage vessel of claim 1, wherein said apertures in said lid having a substantially conical inner surface converging toward said bottom face and wherein said apertures are arranged in a plurality of rows.

6. The storage vessel of claim 1, wherein said apertures encompass less than 10% of a surface area of said top face.

7. The storage vessel of claim 1, wherein said cooling member comprises a base having a bottom wall and a side wall defining a cavity for receiving a heat exchange fluid.

8. The storage vessel of claim 7, wherein said reservoir comprises a top plate having a bottom wall and a side wall defining said cavity for said liquid, and wherein said top plate is nested in said base.

9. The storage vessel of claim 8, wherein said base includes a fluid inlet and a fluid outlet, and a channel in said bottom wall of said base extending between said fluid inlet and said fluid outlet.

10. The storage vessel of claim 9, wherein said channel has an open top end facing said bottom wall of said top plate whereby said heat exchange fluid passing through said channel is in heat exchange contact with said bottom wall of said top plate.

11. The storage vessel of claim 8, wherein said top plate has an open top and wherein said lid is removably coupled to said top plate to close said open top of said top plate.

12. The storage vessel of claim 8, wherein said top plate has a flange extending outwardly from a top end of said side wall of said top plate, said flange being coupled to a top end of said side wall of said base.

13. The storage vessel of claim 12, further comprising a gasket positioned between said flange and said base forming a fluid seal.

14. The storage vessel of claim 1, further comprising a volatile liquid contained in said reservoir.

15. The storage vessel of claim 14, wherein said volatile liquid contains a solute.

16. A pipetting apparatus for pipetting a liquid sample, said apparatus comprising:
at least one pipette;
a sample receiving support;
a storage vessel having a closed reservoir with an internal cavity for containing a liquid, said storage vessel having at least one aperture extending into said cavity and having a dimension to allow said pipette to pass through said aperture; and
an operating assembly to position said pipette in said at least one aperture and to pipette a liquid sample from said storage vessel, and to deposit said liquid sample onto said sample receiving support.

17. The apparatus of claim 16, wherein said reservoir has an open top end, and said storage vessel includes a lid to close said open top end of said reservoir, and wherein said at least one aperture is formed in said lid.

18. The apparatus of claim 16, wherein said pipetting apparatus is an automated pipetting assembly and said operating assembly includes a conveyor supporting said sample receiving support and said storage vessel, said conveyor being operable to move said sample-receiving plate and storage vessel into an operating position with said at least one pipette.

19. The apparatus of claim 18, wherein said operating assembly further comprises a lifting assembly for lifting said sample receiving support and storage vessel to an operating position with respect to said pipette.

20. The apparatus of claim 16, comprising a plurality of said pipettes arranged in an array, and wherein said storage vessel includes a plurality of said apertures spaced apart corresponding to a spacing of said pipettes, wherein said apertures are able to receive a respective pipette simultaneously and each of said pipettes aspirate a liquid sample simultaneously from said storage vessel.

21. The apparatus of claim 16, wherein said sample receiving support is a mass spectrometry plate.

22. The apparatus of claim 16, wherein said storage vessel includes an internal channel for receiving a heat exchange fluid to cool said internal cavity, a fluid inlet for supplying said heat exchange fluid to said internal channel, and a fluid outlet for discharging said heat exchange fluid from said channel.

23. The apparatus of claim 22, further comprising a heat exchange device operatively connected to said storage vessel for cooling said heat exchange fluid.

24. The apparatus of claim 20, wherein each of said apertures in said storage vessel have a substantially conical inner surface converging toward said internal cavity and wherein said apertures are arranged in rows.

25. The apparatus of claim 16, wherein said storage vessel comprises a base and a top plate, said base having a bottom wall and a side wall defining a cavity for receiving a heat exchange fluid between said base and said top plate, and said top plate having a bottom wall and a side wall defining said internal cavity of said storage vessel for said liquid, and wherein said top plate is nested in said base.

26. The apparatus of claim 25, wherein said base includes a fluid inlet and a fluid outlet, and wherein said bottom wall of said base includes a channel extending between said fluid inlet and said fluid outlet.

27. The apparatus of claim 26, wherein said channel has an open top end facing said top plate, whereby a fluid passing through said channel is in heat exchange contact with said bottom wall of said top plate.

28. The apparatus of claim 25, wherein said top plate has an open top and wherein said storage vessel includes a lid coupled to said top plate to close said open top and wherein said lid comprises a plurality of said at least one apertures arranged in rows.

29. The apparatus of claim 28, wherein said apertures encompass less than 10% of a surface area of a top face of said lid.

30. The apparatus of claim 28, wherein said top plate has a flange extending outwardly from a top end of said side wall of said top plate, said flange being coupled to a top end of said side wall of said base.

31. A method for reducing evaporation of and loading a volatile liquid onto a sample plate, said method comprising the steps of:
providing a storage vessel containing said volatile liquid and cooling said storage vessel to cool said volatile liquid to a temperature sufficient to reduce evaporation, said storage vessel having a closed internal cavity and at least one aperture into said internal cavity;
inserting a pipette through said at least one aperture into said storage vessel containing said volatile substance;
aspirating a volume of said volatile liquid into said pipette; and
depositing said volatile liquid on said sample plate.

32. The method of claim 31, wherein said volatile liquid contains a solute, and said method comprises maintaining said solvent at a temperature sufficient to maintain a substantially constant concentration of said solute in said volatile liquid.

33. The method of claim 31, wherein said solute is a mass spectrometry matrix material.

34. The method of claim 33, wherein said sample plate includes a sample and said method comprises depositing said solvent and solute onto said sample.

35. The method of claim 31, wherein said sample plate includes a sample and a mass spectrometry matrix material, and said method comprises depositing said volatile liquid on said sample and matrix material, dissolving said matrix material and crystallizing said matrix material on said sample plate.

36. The method of claim 31, further comprising the steps of aspirating a liquid sample from a sample vessel into said pipette, and depositing said sample onto said sample plate.

37. The method of claim 36, comprising the steps of:
positioning said sample vessel below said pipette and raising said sample vessel into an operating position with respect to said pipette and aspirating said sample from said sample vessel.

38. The method of claim 31, wherein said sample plate is a mass spectrometry sample plate.

39. The method of claim 31, wherein said storage vessel has an internal channel and said method comprises circulating a cooling fluid through said channel and cooling said volatile liquid.

40. The method of claim 31, wherein said storage vessel includes a lid having an aperture, and said method comprising inserting said pipette through said aperture into said volatile liquid and aspirating said volume of said volatile liquid.

41. The method of claim 29, further comprising an automated pipetting assembly having a plurality of pipettes, and wherein said method comprises systematically depositing said volatile liquid onto said sample plate.

42. A method of forming a sample onto a mass spectrometry support plate, said method comprising the steps of:
depositing a sample onto a mass spectrometry support plate, providing a volatile solvent in a storage vessel and maintaining said solvent at a temperature below room temperature to inhibit evaporation,
aspirating a volume of said solvent from said storage vessel in a pipette,
depositing at least a portion of said volume of said solvent from said pipette onto said sample on said support plate, and dispersing said sample and mass spectrometry matrix material in said solvent, and
evaporating said solvent and crystallizing said matrix material on said support plate.

43. The method of claim 42, wherein said sample on said support plate includes said matrix material before depositing solvent onto said sample.

44. The method of claim 42, wherein said solvent is a solution of said matrix material.

45. The method of claim 42, wherein said storage vessel includes an internal channel and said method comprises circulating a cooling fluid through said channel and cooling said solvent to a temperature to a temperature to inhibit evaporation.

46. The method of claim 45, wherein said storage vessel includes a cavity containing said solvent and a lid enclosing a cavity, said lid including an aperture, and wherein said method comprises inserting said pipette through said aperture into said solvent and aspirating said volume of said solvent.

47. The method of claim 46, wherein said volatile solvent has a vapor pressure of at least about 3.5 kPa at 25° C.

48. The method of claim 42, comprising an automated pipetting assembly having a plurality of said pipettes, and wherein said method comprises systematically depositing a plurality of said samples on said support plate and depositing said solution on said samples.
